(19) United States
(12) Patent Application Publication
(10) Pub. No.: US 2018/0008085 A1
(43) Pub. Date: Jan. 11, 2018

(54) SYSTEM FOR REFILLING BEVERAGE DISPENSER WITH POWDER

(71) Applicant: NESTEC S.A., Vevey (CH)

(72) Inventors: Flavien Dubief, Champagne (CH); Lucio Scorrano, Yverdon-les-Bains (CH); Larry Baudet, Denges (CH); Kevin Jamolli, Bursins (CH)

(21) Appl. No.: 15/546,039

(22) PCT Filed: Jan. 18, 2016
(86) PCT No.: PCT/EP2016/050926

§ 371 Date: Jul. 25, 2017

(30) Foreign Application Priority Data
Jan. 29, 2015 (EP) 15153048.2

(51) Int. Cl. A47J 31/40; A47J 31/44; B65B 1/06; B65D 83/06

(52) U.S. Cl. CPC A47J 31/404; B65B 1/06; A47J 31/4403; B65D 83/06

(57) ABSTRACT

The invention concerns a system of a container for storing a food or beverage powder and powder refilling container for refilling said container with powder, in which: the container comprises a tank and a powder inlet, the powder refilling container comprises a powder outlet, the powder outlet of the powder refilling container and the powder inlet of the tank being designed for cooperating together in order to create a connection and a path for powder between the powder outlet of the powder refilling container and the powder inlet of the tank, and wherein said connection between the powder outlet of the powder refilling container and the powder inlet of the tank is designed so that it enables the positioning of the powder outlet of the powder refilling container relatively to the powder inlet of the tank in at least two positions: one first position, in which powder cannot flow through the path, and one second position, in which powder is able to flow through the path, wherein the powder inlet of the tank is movable between two positions and, once the powder outlet of the powder refilling container and the powder inlet are connected, the movement of the powder inlet induces the positioning of the powder outlet of the powder refilling container in the first or second position.

### FIELD OF THE INVENTION

The present invention relates to beverage dispensers preparing beverages from a soluble powder stored in a container and from which a dose of powder is dispensed to prepare a beverage.

### BACKGROUND OF THE INVENTION

Many beverages like espresso and other coffee beverages, milk beverages, chocolate beverages are prepared by mixing a soluble food or beverage powder with a diluent in a mixing device. The mixing device can comprise a dissolution chamber in which the soluble component and the diluent are fed. The diluent can be introduced into the dissolution chamber in order to create a whirlpool to efficiently dissolve the soluble powder in the hot water or the hot diluent can be introduced under the form of jets that provides mixing, dissolving and frothing. The mixture can also eventually be frothed by a whipper in the dissolution chamber to reconstitute the beverage and produce foam. The beverage is then usually evacuated into a receptacle for drinking. These devices can also mix the beverage soluble powder with the diluent in a drinking cup, usually a single use cup. In that case the soluble food component is introduced in the cup and the diluent is introduced under the form of jets that provides mixing, dissolving and/or frothing.

Whatever the way the powder and the diluent are mixed together the beverage soluble powder is usually stored in a container placed above the dissolution chamber opened mouth and a dosing device like a screw or an auger doses and delivers the beverage soluble powder which falls in the dissolution chamber or the drinking cup. Diluent is simultaneously fed to the dissolution chamber so that dissolution occurs.

The container storing the food or beverage powder comprises a tank with a removable lid at the top. The container can be refilled with powder by removing the lid and replenishing the tank. This operation is usually implemented by means of simple powder refilling container of food of beverage powder. The top of the powder refilling container is cut or torn and the powder is emptied in the container tank.

This current practice present several disadvantages.

First the refilling can be very messy because powder can flow around the container during the operation of transfer. If the operator manipulating the powder refilling container is clumsy, the place inside or around the machine can very rapidly becomes messy and dirty with the difficulty to efficiently removes powder and makes the place proper.

Secondly beverage dispensers often comprise several food or beverage containers comprising different powders for preparing different beverages. For example, beverage dispensers often comprise an instant coffee powder container and a milk powder container. It is important to refill the containers with always the same powder for different reasons. One reason is that no powder must be contaminated by other types of powders in order to not affect the final taste of the beverage ordered by the customer.

Another reason is that usually each container is associated to a specific dosing device and the dosing device associated to one container is set for dosing a particular amount of a particular powder in order to provide the expected dissolution with the diluent. Erroneously refilling a container with a wrong powder leads to an incorrect preparation of the beverage by the dispenser.

There is a need for improving the refilling of powder containers within a beverage dispenser.

An object of the present invention is to provide a system of a container for storing powder in a beverage dispenser and a powder refilling container for refilling said container.

It would be advantageous to provide a system that limits the spilling of powder during refilling.

It would be advantageous to provide a system that avoids the risk of erroneous refilling of powder containers.

It would be advantageous to provide an ergonomic system to refill powder tanks.

### SUMMARY OF THE INVENTION

In a first aspect of the invention, there is provided a system of a tank for storing a food or beverage powder and a powder refilling container for refilling said tank with powder, in which:
the tank comprises a storing chamber and a powder inlet,
the powder refilling container comprises a powder outlet,

the powder outlet of the powder refilling container and the powder inlet of the tank being designed for cooperating together in order to create a connection and a path for powder between the powder outlet of the powder refilling container and the powder inlet of the tank, and

wherein said connection between the powder outlet of the powder refilling container and the powder inlet of the tank is designed so that it enables the positioning of the powder outlet of the powder refilling container relatively to the powder inlet of the tank in at least two positions:
one first position, in which powder cannot flow through the path, and
one second position, in which powder is able to flow through the path,

wherein the powder inlet of the tank is movable between two positions and, once the powder outlet of the powder refilling container and the powder inlet of the tank are connected, the movement of the powder inlet induces the positioning of the powder outlet of the powder refilling container in the first or second position.

Generally the tank for storing the food or beverage powder is a device that is part of a beverage dispenser. It is generally non disposable. Depending on the configuration of the dispenser, it can be removed from the dispenser, for example for maintenance or cleaning, and eventually for refilling.

The tank comprises a powder outlet, generally positioned at the bottom of the storing chamber of the tank.

Preferably the tank is a storing and dosing tank. Then it comprises a dosing device, generally positioned at the bottom of the tank and delivering dose of powder through the powder outlet of the tank. The dosing device can be a rotatable volumetric dosing device like an endless screw or, alternatively, a helicoidal spring, also known as spring auger.

The tank with a dosing device is usually configured for enabling the connection of the dosing device with a motorized shaft at the rear end of the tank, said shaft being part of the beverage dispenser.

According to another embodiment the dosing device is not part of the tank. In that embodiment the dosing device can be part of the beverage dispenser and the tank is a simple storing tank that comprises a powder outlet for dispensing powder to a dosing device within a beverage dispenser. In this embodiment, preferably, the powder outlet comprises a device enabling the opening of the outlet of the tank during dosing operation.

Generally the storing chamber of the tank presents globally the shape of a parallelepiped. It usually presents two lateral walls, two end walls, usually one rear end wall and one front end wall, and a bottom wall. The walls extend between the bottom and the top of the tank and are essentially vertical. By essentially vertical it is meant that some parts of the walls can be inclined, generally to create a funnel above the bottom of the tank. For example, when the tank comprises an endless dosing screw at its bottom, the inclination of the walls increases the storing volume of the storing chamber above the screw and creates a funnel that guides powder to the screw.

The top of the container is closed by a lid. The lid can be a removable lid in order to be able to clean the container or for maintenance of the dosing device for example.

Generally the container for refilling the container with powder is a disposable container. It is preferably a pouch, usually made of flexible film sheets.

The powder outlet of the powder refilling container and the powder inlet of the tank are designed for cooperating together in order to create a connection and a closed path for powder between the powder outlet of the powder refilling container and the powder inlet of the tank. The connection usually enables either the powder outlet for the container to fit in the powder inlet of the tank.

The connection between the powder outlet of the powder refilling container and the powder inlet of the tank is designed so that it enables the positioning of the powder outlet relatively to the powder inlet of the tank in at least two positions:
one first position, in which the powder outlet of the container and the powder inlet of the tank cooperate and are connected but do not create a path for powder between the powder outlet of the powder refilling container and the powder inlet of the tank.
one second position, in which the powder outlet of the container and the powder inlet of the tank cooperate and are connected and there is path for powder between them.

Generally the flow path created in the second position is essentially straight.

Preferably the flow path is essentially downwardly orientated from the powder outlet of the powder refilling container to the powder inlet of the tank.

In the second position, the flow path can present an angle of at most 60° with vertical, preferably at most 45°. The value of the angle can depend on the nature of the powder and its flowability.

Accordingly in the first position, the connection is created but there is no path for powder. This position enables the operator to correctly connect the powder outlet of the powder refilling container with the powder inlet of the tank without any risk that powder may fall around because there is no path for powder.

And accordingly once the powder outlet of the tank is positioned in the second position, a flow path is created for powder and powder can flow from the container to the tank by gravity.

Preferably the connection between the powder outlet of the powder refilling container and the powder inlet of the tank is designed so that, once the powder inlet and the powder outlet are connected, the connection enables the positioning of the powder outlet of the powder refilling container:
in the first position so that the powder outlet of the powder refilling container is oriented upwardly,
in the second position so that the powder outlet of the powder refilling container is oriented downwardly.

The powder inlet of the tank is movable between two positions and, once the powder outlet of the powder refilling container and the powder inlet are connected, the movement of the powder inlet induces the positioning of the powder outlet of the powder refilling container in the first or second position.

Preferably the powder inlet of the tank comprises at least a tube, said tube presenting an external end and an internal end, said external end being connectable to the powder outlet of the powder refilling container, and said tube being configured for being oriented in at least two positions:
one first position, in which the tube is essentially horizontally oriented,
one second position, in which the tube is inclined compared to the first position and downwardly oriented from the external end to the internal end.

Accordingly the tube of the powder inlet of the tank is movable between two positions and, once the powder outlet of the powder refilling container is connected to the tube, then the movement of the tube moves the powder outlet of the container in order to have powder flowing through the tube, generally by gravity.

According to a first mode, the powder inlet of the tank comprises a straight tube, the powder outlet of the powder refilling container being designed for sliding inside said tube of the powder inlet of the tank, and the tube of the powder inlet of the tank being rotatable in a vertical plane.

Generally the tank for storing powder presents the shape of a parallelepiped, said parallelepiped comprising a horizontal bottom wall, two lateral essentially vertical walls and two essentially vertical end walls, usually one rear end wall and one front end wall. Preferably the tube of the powder inlet of the tank is rotatable in the vertical plane parallel to two lateral essentially vertical walls.

Preferably the powder inlet comprises a support for holding the straight tube of the powder inlet, the straight tube being attached to the support in a rotatable manner.

Generally, according to said first mode, the powder outlet of the powder refilling container comprises a tube designed for sliding inside the tube of the powder inlet of the tank.

According to a second mode,
the powder inlet of the tank comprises an opening at the upper part of the tank, and
the tube of the powder inlet of the tank is able to slide in the opening at the upper part of the tank between a retracted position in the tank and a pulled position outside of the tank, and said tube is designed so that:
in the retracted position, the tube is essentially horizontally oriented, and
in the pulled position, the tube is inclined compared to the first position and downwardly oriented from the external end to the internal end.

Preferably the tube is designed so as to present an elbow near from its external end.

Preferably the tank can comprise a supporting device inside the tank in order to support and guide the movement of the tube during its movement between a pulled and retracted position.

The tank can comprise a ring made of elastomer at the connection between the tube of the powder inlet and the opening at the upper part of the tank in order to create a pivot at their point of contact.

According to a third mode the powder inlet of the tank comprises a flexible tube orientatable between:
one first position, in which the external end of the tube is oriented downwardly,
one second position, in which the external end of the tube is oriented upwardly.

Preferably the flexible tube presents a sufficient length so that the powder refilling container can be freely oriented while attached to the flexible tube.

Whatever the mode, the powder outlet of the powder refilling container and the powder inlet of the tank can comprise cooperating fool-proofing shapes.

Preferably the powder outlet of the powder refilling container is a tube and the external walls of the tube comprise at least one guiding groove or guiding pin for cooperation with a corresponding guiding pin or groove of the tube of the powder inlet of the tank.

Whatever the mode, the tank can comprise a removable cover for closing the powder inlet.

In a second aspect there is provided a beverage dispenser comprising at least one tank for storing and dosing food or beverage powder, said tank being refillable by powder, wherein the tank comprises a storing chamber and a powder inlet and said powder inlet is designed for cooperating with the powder outlet of a powder refilling container in order to create a connection and a path for powder,

wherein the power inlet comprises at least a tube, said tube presenting an external end and an internal end, said external end being connectable to the powder outlet of the powder refilling container,

and the tube being configured for being oriented in at least two positions:
one first position, in which the tube is essentially horizontally oriented,
one second position, in which the tube is inclined compared to the first position and downwardly oriented from the external end to the internal end.

Preferably the powder inlet of the tank is positioned at the front side of the dispenser.

The powder inlet of the tank can be positioned behind a front door.

The powder inlet of the tank can be positioned at the upper part of the front side of the dispenser.

Accordingly the operator can get access to the powder inlet of the tank by simply opening the front door of the dispenser or by simply opening a cover at the powder inlet of the tank.

According to a first mode the powder inlet of the tank can comprise a straight tube and the tube of the powder inlet of the tank can be rotatable in a vertical plane.

According to a second mode:
the powder inlet of the tank comprises an opening at the upper part of the tank, and
the tube of the powder inlet of the tank is able to slide in said opening at the upper part of the tank between a retracted position in the tank and a pulled position outside of the tank, and wherein said tube is designed so that:
in the retracted position, the tube is essentially horizontally oriented, and
in the pulled position, the tube is inclined compared to the first position and downwardly oriented from the external end to the internal end.

According to a third mode, the powder inlet of the tank comprises a flexible tube orientatable between:
one first position, in which the external end of the tube is oriented downwardly,
one second position, in which the external end of the tube is oriented upwardly

Whatever the mode, preferably, the internal wall of the tube comprises at least one guiding groove or guiding pin for cooperation with the powder outlet of a powder refilling container.

Whatever the mode, generally, the dispenser comprises at least two containers storing different powders and the powder inlets of the containers are designed differently for being connected to different corresponding powder refilling container storing different powders.

Accordingly to the preferred embodiment the tubes of the different containers can present different guiding grooves or guiding pins in order to be able to be connected to one corresponding powder outlet of the powder refilling container only.

According to a third aspect, there is provided a method for refilling a tank for storing powder with a powder refilling container of a system such as described above wherein the following steps are implemented:
the powder outlet of the powder refilling container is connected to the powder inlet of the tank in the first position, and then
the powder inlet of the tank is moved to position the powder outlet of the powder refilling container in the second position.

Then for stopping the refilling of the tank, the following steps are implemented:
the powder inlet of the tank is moved to position the powder outlet of the powder refilling container in the first position,
the powder outlet of the powder refilling container is removed from the powder inlet of the tank.

Accordingly the removal operation corresponds to the inversed movements.

In the present invention the term “powder” covers a bulk material like powder, free flowing particles, pellets, granulates, granules, grains (like coffee beans) or leaves (like tea leaves). Preferably, the food or beverage powder can be instant or roast and ground coffee, chocolate, instant tea, milk powder, soup or a coffee mix.

In the present application the terms “downwardly” “internal”, “external”, “rear”, “front”, “top”, “bottom” and “lateral” are used to describe the relational positioning of features of the invention. These terms should be understood to refer to the different devices of the invention in their normal orientation during refilling operation, as far as the powder refilling container is concerned, and as positioned in a beverage preparation dispenser for the production of a beverage, as far as the tank is concerned, as shown in figures.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

The characteristics and advantages of the invention will be better understood in relation to the following figures:

FIG. 1 is a partial view of a dispenser according to the present invention illustrating the soluble beverage powder container,

FIGS. 2a-2c illustrate the cooperation between the container and the powder refilling container of the system according to the first mode,

FIGS. 3a and 3b illustrate e cooperation between the container and the powder refilling container of the system according to the second mode,

FIGS. 4a-4c illustrate the cooperation between the container and the powder refilling container of the system according to the third mode,

FIG. 5 illustrates a beverage dispenser according to the present invention.

### DETAILED DESCRIPTION OF THE DRAWINGS

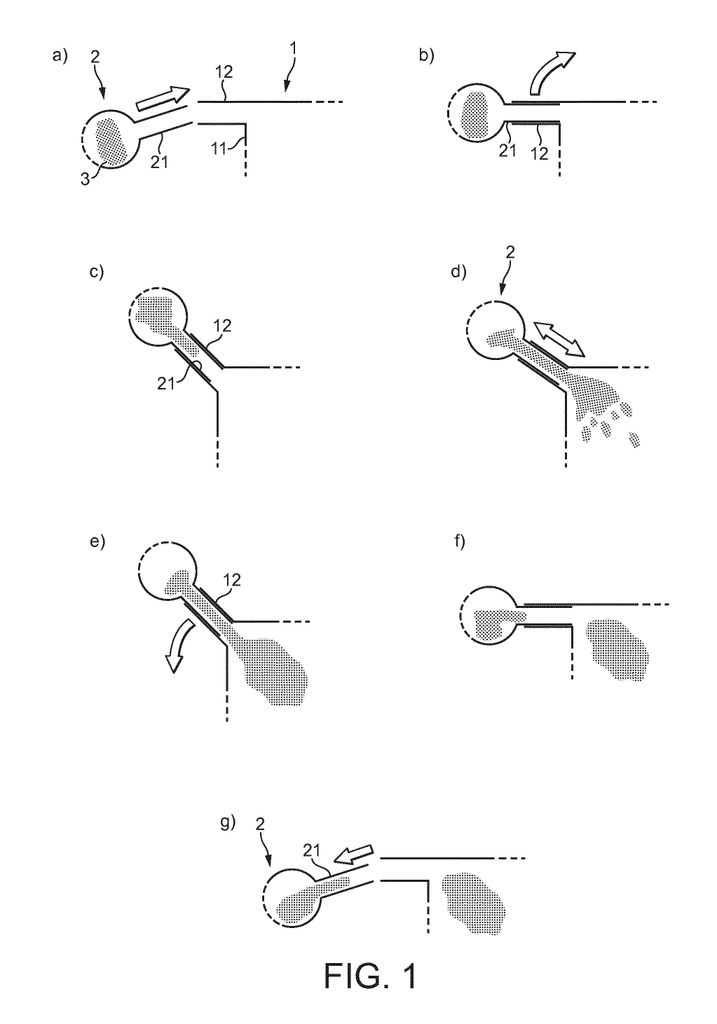

FIG. 1 illustrates schematically a system according to the present invention and the different steps for connecting the different parts of the system. The system comprises a tank 1 for storing a food or beverage powder and a powder refilling container 2 for refilling said tank with powder 3.

The tank 1 comprises a storing chamber 11 and a powder inlet 12 through which powder can be introduced for the refilling of the tank. Usually this tank 1 is a storing and dosing tank of a beverage dispenser, also frequently called canister. Such a tank usually comprises a powder outlet positioned at the bottom of the tank from which powder is dosed for preparing a beverage. Preferably the bottom of the tank comprises a dosing device like a screw auger or a spring auger. Consequently, in this type of tank, powder is evacuated from the tank through the bottom of the tank and powder has to be refilled in the tank regularly.

The powder refilling container 2 is conceived for storing a powder 3. It is usually a pouch. The powder refilling container comprises a powder outlet 21. The powder outlet is generally a tube. The tube can present any sectional shape. Preferably the shape is conformal to the shape of the powder inlet of the tank.

The powder outlet 21 of the powder refilling container and the powder inlet 12 of the tank are designed for cooperating together in order to transfer the powder of the powder refilling container to the tank 11 and refill the tank. The cooperation consists in creating a connection and a path for powder between the powder outlet of the powder refilling container and the powder inlet of the tank.

As illustrated in steps a) and b) of FIG. 1, when the powder outlet 21 of the powder refilling container is connected to the powder inlet 12 of the tank, the powder outlet is in a first position in which there is a path for powder, but due to the fact that the powder outlet 21 is oriented essentially horizontally, or even upwardly, powder cannot flow through the path. In the first position illustrated in step b), a path is created for powder but powder cannot flow through.

Once the powder outlet 21 is connected in the first position of step b), the powder inlet 12 can be rotated so as to reach the position illustrated in step c). In this position the powder outlet 21 of the powder refilling container is oriented downwardly. As a result powder can flow due to gravity from the powder refilling container 2 to the storing chamber 11 of the tank. Optionally the connection in this second position can enable a back and forth movement of the powder outlet 21 of the powder refilling container to accelerate and improve the filling of powder as illustrated in step d).

To stop the refilling operation, the powder inlet 12 of the tank is rotated back in the first position as illustrated in step e) which induces the movement of the powder outlet of the powder refilling container to reach a horizontal orientation as illustrated in step f).

Finally the powder refilling container 2 can disconnected from the tank by pulling out the powder refilling container as illustrated in step g).

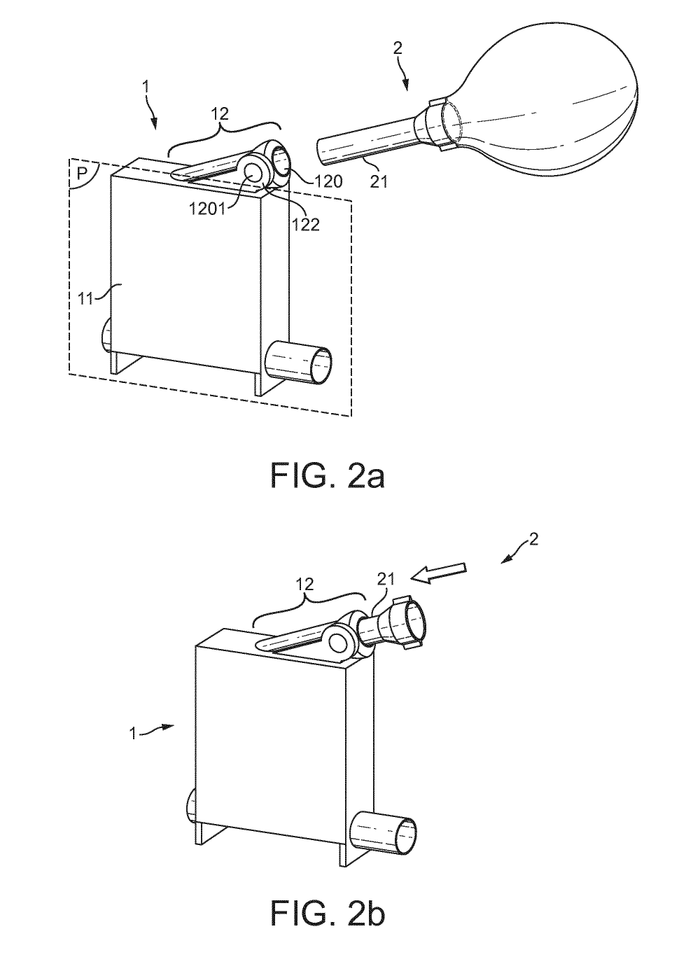

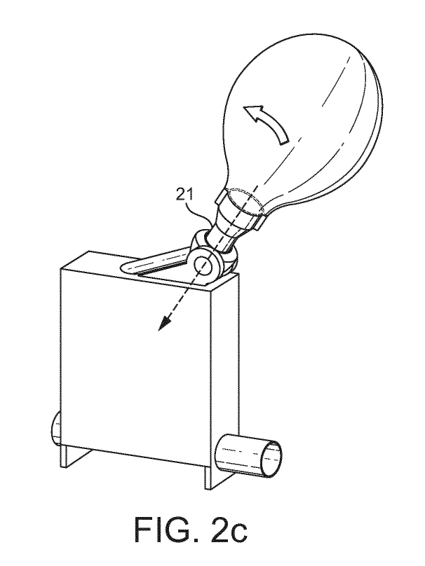

FIG. 2a illustrates a system of a tank 1 and a powder refilling container 2 according to the first mode of the present invention. The tank 1 comprises a storing chamber 11 and a powder inlet 12. The powder inlet 12 protrudes at the upper part of the tank.

The powder inlet 12 comprises a straight tube 120. The powder inlet comprises a support 121 for the tube configured for supporting the tube at the top of the tank and for moving the tube between two positions. The tube 120 presents two pins 1201 on its lateral sides cooperating with two holes 1221 in the support, the cooperation enabling the rotation of the tube 120 of the powder inlet in the support and along the vertical plane P corresponding to the vertical longitudinal plane of the tank 11.

Preferably the powder inlet is attached to the top of the tank and is not removable therefrom, except for cleaning or maintenance. Consequently the operator has not the ability to refill the tank 1 by other ways than through the powder inlet 12.

The powder refilling container 2 comprises a powder outlet 21. The powder outlet is a straight tube 21 presenting a shape designed for fitting inside the tube 120 of the powder inlet of the tank. Preferably the external surface of the tube 21 of the powder outlet of the powder refilling container presents pins or slots for fitting with corresponding slots or pins respectively on the internal surface of the tube 120 of the powder inlet of the tank.

FIG. 2b illustrates the system with the tube 21 of the powder refilling container being introduced inside the tube 120 of the powder inlet of the tank. In this step the tube 120 is oriented essentially horizontally and the tube 21 has to be introduced with the same orientation inside the powder inlet of the tank. Consequently, at this step, the powder in the powder refilling container 2 cannot flow in the path created by the connection of the tubes 120, 21.

FIG. 2c illustrates the following step wherein the assembly of the two tubes 120, 21 is rotated in order to enable the flow of powder. Due to the fact that the tube 120 of the powder inlet of the tank can be rotated, said tube can be inclined to reach the second illustrated position and said tube can simultaneously incline the powder outlet 21 of the powder refilling container enabling powder refilling.

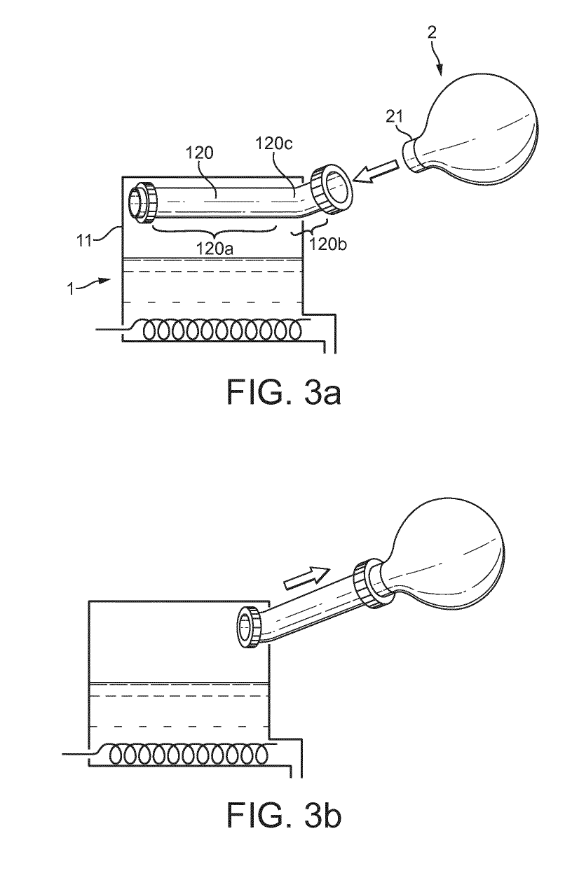

FIGS. 3a-3b illustrate a system of a tank 1 and a powder refilling container 2 according to the second mode of the present invention.

The powder inlet of the tank comprises an opening 123 at the upper part of the rear front of the tank and a tube 120 that is able to slide in said opening. The opening 123 is surrounded a by a ring 124, preferably made of elastomer, to enable tightness with the tube. Such a ring also enables the tube to pivot and to be more easily orientatable when pulled out.

The tube is able to move between a retracted position (FIG. 3a) in the tank and a pulled position (FIG. 3b) outside of the tank.

In the retracted position, the tube is essentially horizontally oriented, and in the pulled position, the tube is inclined compared to the first position and downwardly oriented from the external end to the internal end.

The tank can comprise a supporting device (not illustrated) inside the tank in order to support and guide the movement of the tube during its movement between a pulled and a retracted position and in particular to maintain the tube horizontally oriented in the upper part of the tank when retracted.

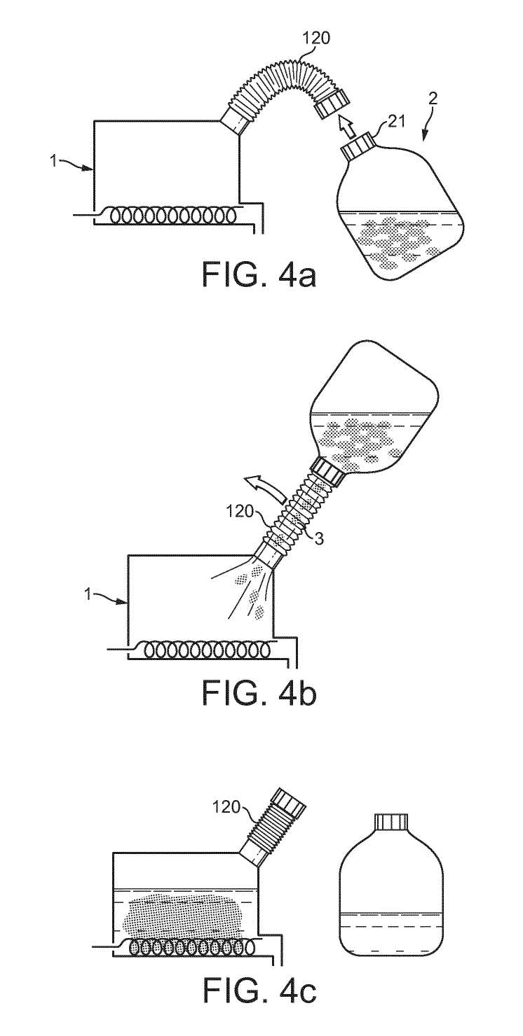

FIG. 4a illustrates a system of a tank 1 and a powder refilling container 2 according to the third mode of the present invention.

The tank 1 comprises a storage chamber 11 and a powder inlet 12. The powder inlet 12 protrudes at the upper part of the tank.

The powder inlet 12 comprises a flexible tube 120. The tube is sufficiently long and sufficiently flexible so as to enable the orientation of the external end of the tube downwardly as illustrated in FIG. 4a. In this position the powder outlet 21 of the powder refilling container 2 can be attached to the flexible tube 120 with the powder outlet oriented upwardly. Accordingly there is no risk that powder falls around the container though the path for powder is created between the two elements.

Preferably the powder outlet 21 and the external end of the tube 120 presents fool-proofing elements to enable the refiling of the container with the tight powder.

FIG. 4b illustrates the step where the external end of the tube is oriented upwardly and, as a consequence, the attached powder outlet 21 of the powder refilling container is oriented downwardly. Powder can flow through the path to the container 1.

To stop refilling, the external end of the flexible tube is oriented downwardly again and the powder refilling container can be disconnected from the tube 120.

FIG. 4c illustrates how the flexible tube can be compressed to save place within the beverage dispenser.

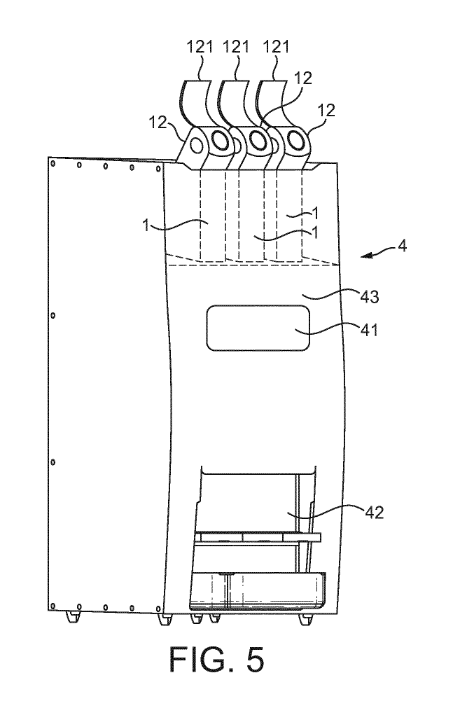

FIG. 5 illustrates a beverage dispenser 4 comprising several beverage powder tanks 1 according to the invention. The tanks are positioned so that the powder inlets 12 are in the front of the dispenser, preferably at the upper part of the dispenser. Accordingly the operator can have direct access to the powder inlets 12 without opening the front door 43 of the dispenser. He/she just has to open the covers 121 of the powder inlets 12. Then the operator does not have to remove the tank form the dispenser for refilling. This operation is usually mandatory in current dispensers because there is a risk that the operator dirties the machine with powder during refilling. But in the present invention there is no such risk.

Behind the front door 13, the dispenser usually comprises beverage preparation units placed under powder tanks 1. The outlets of the tanks are oriented so as to deliver the beverage powder in the beverage preparation for contacting a dose of beverage powder with a diluent. The diluent is supplied by a fluid system comprising usually a boiler, a pump and a heater placed in the back part of the dispenser (not illustrated). The beverage preparation unit 21 delivers the beverage in a cup placed in a dispensing area 42.

The dispenser usually comprises an input device 41 for enabling a customer to select and order a beverage.

The tanks 1 can cooperate with motor shafts at their rear end in order to actuate the dosing devices inside the containers.

Advantageously it is possible to retrofit existing powder tanks for storing and dosing a food or beverage powder of existing dispensers by simply removing the lid and replacing it with a lid comprising a powder inlet in order to cooperate with a powder refilling container according to the invention. Eventually the front door of the dispenser may be adapted too.

The system of the present invention presents the advantage of inducing the operator to do the right refilling movement to orientate the powder refilling container in a manner that avoids any spilling of powder.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

tank 1
storing chamber 11
powder inlet 12
   tube 120
      pin 1201
   support 122
      hole 1221
   opening 123
   ring 124

powder refilling container 2
powder outlet 21

powder 3

dispenser 4
input device 41
dispensing area 42
front side 43

1. System of a container for storing a food or beverage powder and a powder refilling container for refilling the tank with powder, wherein:
the tank comprises a storing chamber and a powder inlet;
the powder refilling container comprises a powder outlet;
the powder outlet of the powder refilling container and the powder inlet of the tank being designed for cooperating together in order to create a connection and a path for powder between the powder outlet of the powder refilling container and the powder inlet of the tank;
the connection between the powder outlet of the powder refilling container and the powder inlet of the tank is designed so that it enables the positioning of the powder outlet of the powder refilling container relatively to the powder inlet of the tank in at least two positions:
one first position, in which powder cannot flow through the path, and one second position, in which powder is able to flow through the path; and
wherein the powder inlet of the tank is movable between two positions and, once the powder outlet of the powder refilling container and the powder inlet are connected, the movement of the powder inlet induces the positioning of the powder outlet of the powder refilling container in the first or second position.

2. System according to claim 1 wherein the connection between the powder outlet of the powder refilling container and the powder inlet of the tank is designed so that once the powder inlet and the powder outlet are connected, the connection enables the positioning of the powder outlet of the powder refilling container:
in the first position so that the powder outlet of the powder refilling container is oriented upwardly; and
in the second position so that the powder outlet of the powder refilling container is oriented downwardly.

3. System according to claim 1 wherein the powder inlet of the tank comprises at least a tube,
the tube presenting an external end and an internal end, the external end being connectable to the powder outlet of the powder refilling container, and
the tube being configured for being oriented in at least two positions:
one first position, in which the tube is essentially horizontally oriented;and
one second position, in which the tube is inclined compared to the first position and downwardly oriented from the external end to the internal end.

4. System according to claim 1, wherein the powder inlet of the tank comprises a straight tube and the tube of the powder inlet of the tank is rotatable in a vertical plane.

5. System according to claim 1, wherein the powder inlet comprises a support for holding the straight tube of the powder inlet, the straight tube being attached to the support in a rotatable manner.

6. System according to claim 3 wherein the powder outlet of the powder refilling container comprises a tube designed for sliding inside the tube of the powder inlet of the tank.

7. System according to any claim 1 wherein:
the powder inlet of the tank comprises an opening at the upper part of the tank, and
the tube of the powder inlet of the tank is able to slide in said opening at the upper part of the tank between a retracted position in the tank and a pulled position outside of the tank,
and wherein said tube is designed so that:
in the retracted position, the tube is essentially horizontally oriented, and
in the pulled position, the tube is inclined compared to the first position and downwardly oriented from the external end to the internal end.

8. System according to claim 1 wherein the powder inlet of the tank comprises a flexible tube orientatable between:
one first position, in which the external end of the tube is oriented downwardly; and
one second position, in which the external end of the tube is oriented upwardly.

9. System according to claim 1 wherein the powder outlet of the powder refilling container and the powder inlet of the tank comprise cooperating fool-proofing shapes.

10. Beverage dispenser comprising at least one tank for storing and dosing food or beverage powder, the tank being refillable by powder, wherein the tank comprises a storing chamber and a powder inlet and said powder inlet is designed for cooperating with the powder outlet of a powder refilling container in order to create a connection and a path for powder,
wherein the power inlet comprises at least a tube, the tube presenting an external end and an internal end, the external end being connectable to the powder outlet of the powder refilling container,
and the tube being configured for being oriented in at least two positions:
one first position, in which the tube is essentially horizontally oriented; and
one second position, in which the tube is inclined compared to the first position and downwardly oriented from the external end to the internal end.

11. Beverage dispenser according to claim 10 wherein the powder inlet of the tank comprises a straight tube and the tube of the powder inlet of the tank being rotatable in a vertical plane.

12. Beverage dispenser according to claim 10 wherein:
the powder inlet of the tank comprises an opening at the upper part of the tank, and
the tube of the powder inlet of the tank is able to slide in said opening at the upper part of the tank between a retracted position in the tank and a pulled position outside of the tank,
and wherein said tube is designed so that:
in the retracted position, the tube is essentially horizontally oriented; and
in the pulled position, the tube is inclined compared to the first position and downwardly oriented from the external end to the internal end.

13. Beverage dispenser according to claim 10 wherein the powder inlet of the tank comprises a flexible tube orientatable between:
one first position, in which the external end of the tube is oriented downwardly; and
one second position, in which the external end of the tube is oriented upwardly.

14. Beverage dispenser according to claim 10 wherein the dispenser comprises at least two tanks storing different powders and the powder inlets of the tanks are designed differently for being connected to different powder refilling containers storing different powders.

15. Method for refilling a tank for storing and dosing powder with a powder refilling container of a system for refilling the tank with powder, wherein the tank comprises a storing chamber and a powder inlet;
the powder refilling container comprises a powder outlet, the powder outlet of the powder refilling container and the powder inlet of the tank being designed for cooperating together in order to create a connection and a path for powder between the powder outlet of the powder refilling container and the powder inlet of the tank, the connection between the powder outlet of the powder refilling container and the powder inlet of the tank is designed so that it enables the positioning of the powder outlet of the powder refilling container relatively to the powder inlet of the tank in at least two positions:
one first position, in which powder cannot flow through the path, and one second position, in which powder is able to flow through the path, and wherein the powder inlet of the tank is movable between two positions and, once the powder outlet of the powder refilling container and the powder inlet are connected, the movement of the powder inlet induces the positioning of the powder outlet of the powder refilling container in the first or second position wherein the following steps are implemented:
the powder outlet of the powder refilling container is connected to the powder inlet of the tank in the first position; and then
the powder inlet of the tank is moved to position the powder outlet of the powder refilling container in the second position.

16. Method according to claim 1 wherein the powder outlet is rotated to position the powder outlet of the powder refilling container in the second position.
